(19) United States
(12) Patent Application Publication
(10) Pub. No.: US 2007/0280040 A1
(43) Pub. Date: Dec. 6, 2007

(54) Method and Apparatus for Mixing at Least Two Fluids in a Micromixing Reactor

(76) Inventors: Rolf Dahlbeck, Bochum (DE); Marcel Dierselhuis, Soest (NL)

Correspondence Address: RATNERPRESTIA, P O BOX 980, VALLEY FORGE, PA, 19482-0980, US

(21) Appl. No.: 10/585,768

(22) PCT Filed: Jan. 12, 2005
(86) PCT No.: PCT/EP05/00212

§ 371 Date: Jun. 18, 2007

(30) Foreign Application Priority Data
Jan. 13, 2004 (DE) 10 2004 001 852.9

(51) Int. Cl. B01J 19/00; B01F 13/00; B01F 15/06; F28D 7/10; B01F 5/04

(52) U.S. Cl. 366/147

(57) ABSTRACT

A method and an apparatus are proposed for mixing at least two fluids in a micromixing reactor constructed from a stack of films or thin plates, wherein a mixing chamber extends transverse to the film planes, and the fluids to be mixed are introduced separately and adjacent one another on the film planes transverse to the longitudinal axis of the mixing chamber, so that the mixing of the fluids takes place directly on their introduction into the mixing chamber, and wherein the resulting mixture is tempered at least on a portion of the circumference of the mixing chamber by a tempering means.

The invention relates to a method and an apparatus for mixing at least two fluids in a micromixing reactor constructed from a stack of films or thin plates.

A micromixing reactor of this kind is known from DE 101 23 092 A1, wherein fluid lamellae for the fluids to be mixed are formed in the film planes. These fluid lamellae are guided together into a total fluid current in the film plane and fed as fluid jet into a swirl chamber, thereby forming an inwardly-flowing fluid spiral, wherein the swirl chamber extends transverse to the stack of films and the drawing-off of the resulting mixture from the centre of the fluid spiral takes place at the end of the swirl chamber.

The invention is based on the object of forming a method and an apparatus of the above-mentioned kind such that the mixing of the fluids can be carried out optimally in accordance with the kinds of fluid to be mixed.

According to the invention, this is achieved in that the fluids to be mixed are introduced separately and adjacent one another on the film planes transverse to the longitudinal axis of the mixing chamber, such that the mixing of the fluids takes place substantially directly on their entry into the mixing chamber or in the opening portion, and the resulting mixture is tempered by a tempering means, that is, cooled or heated in accordance with the fluids to be mixed.

The tempering means allows the most precise possible isothermal temperature control to be achieved while mixing the fluids, when an exothermic or endothermic reaction takes place between the fluids to be mixed.

According to the invention, the term mixing is to be understood broadly and also includes the manufacture of emulsions and dispersions. The fluids are to be understood as a great variety of gases and free-flowing media.

In a preferred exemplary embodiment, the method comprises at least three method steps: the feeding of at least two fluids as two or more partial currents into one or a plurality of mixing/reaction chambers, wherein the partial currents are fed in from at least two sides in fluid partial currents positioned adjacent and/or above one another, such that they impinge upon a tempering cylinder provided preferably centrally in the middle of the mixing/reaction chamber, and they flow at least partially around this cylinder. Simultaneously with the beginning mixing reaction, in a second method step, the controlling of the mixing reaction is carried out by the above-mentioned tempering cylinder and/or tempering means provided on the outside of the mixing/reaction chamber, such that an isothermal mixing reaction takes place optimally. In a third method step, the mixture is continuously drawn off from an annular opening in the bottom or in the cover of the mixing/reaction chamber.

The central tempering cylinder effects a splitting-up of the single fluid currents into two partial fluid currents having approximately the same size and moving in a clock-wise and an anti-clockwise direction around the tempering cylinder for contacting the opposite partial fluid currents of other reactants if possible. In an alternative way of conducting the process, the partial fluid currents are introduced into the mixing/reaction chamber with a preferred rotational direction. The intimate contact with the central tempering cylinder supports the isothermal way of conducting the process.

In a preferred further embodiment, the partial currents of the fluids are fed into the mixing/reaction chamber in such a way that two adjacent partial currents of different fluids preferably immediately cross one another.

For determining the temperature in an advantageous way, a temperature sensor is integrated in or adjacent the mixing/reaction chamber, preferably in or on the outlet opening for the mixture. Temperature measurement is carried out preferably by means of thermoelements, resistance thermometers, or thermistors, or by radiation measurement.

Tempering is carried out advantageously by means of a fluid which draws off heat resulting from an exothermic mixing reaction or supplies heat necessary for an endothermic mixing reaction. Particularly advantangeously, the heat necessary for an endothermic mixing reaction can also be supplied electrically to the tempering means, for example to a resistance heater.

In an endothermic mixing reaction, the fluids are advantageously already fed to the mixing/reaction chambers at the necessary temperature, so that the tempering means must supply only the heat transformed in the endothermic mixing reaction, so that the fluids have the same temperature over the whole extent of the mixing/reaction chambers. This is carried out advantageously by heating means which are each provided between two films which have supply passages for the fluid partial currents.

The microstructures present in the mixing/reaction chambers achieve faster mixing of the partial currents of the fluids, so that due to the swirling, diffusive mixing is favoured and in most cases one single cycle of the three method steps described is sufficient.

Advantageously, the resulting mixture can be improved by connecting the mixing/reaction chambers in series.

Due to the microstructures present in the mixing/reaction chamber and the faster mixing of the fluid partial currents which is effected by these microstructures, the mixing/reaction chamber can be designed to have a short length, preferably between 1 mm and 20 mm. In an advantageous way, this supports a compact structural shape and the integration of the method in small dimensioned devices, preferably in microreaction systems as known from DE 103 35 038, DE 199 17 330 A1 and DE 202 01 753 U1.

In a further embodiment, a fluid, preferably a fluid containing an auxiliary substance stabilizing the mixture or a fluid carrying a catalyst, is fed into the mixing/reaction chambers through an opening opposite the outlet for the mixture, wherein the opening is opposite the outlet in the axial direction of the apparatus. Hereby, the auxiliary substance or catalyst has a particularly long dwell time in the mixing/reaction chambers. Alternatively, the auxiliary substance or catalyst can also have already been admixed to one or a plurality of fluids. In particular, the auxiliary substance or catalyst can also be added to the individual fluids in partial currents, wherein the individual fluids are fed into the mixing chamber on every plane of the individual plates or films provided with the supply passages.

In an advantageous embodiment, a propelling fluid (for example an inert gas or a liquid) is fed in through the openings opposite the outlets of the mixing/reaction chambers, by which the dwell time of the mixed medium in the mixing/reaction chambers can be substantially shortened. This is particularly advantageous in extremely fast mixing reactions.

In an advantageous embodiment, in the mixing/reaction chambers there are microstructures which break, bend and divert the fluid partial currents, by means of which additional intensive swirling of the fluid partial currents results.

In a further advantageous embodiment, the inside walls of the mixing/reaction chambers and the microstructures present in the mixing/reaction chambers are coated with a catalyst, or the microstructures and/or the films or plates can be made of a material having a catalytic effect.

Preferably, partial currents are not fed adjacent the outlet opening into the mixing/reaction chambers, but at a distance thereabove, so that the partial currents fed in on the lowest plane must still flow through a sufficient mixing length to the outlet.

In a preferred device for mixing at least two fluids, the fluids are fed into the mixing/reaction chambers separately from at least two sides in fluid partial currents which are adjacent or above one another, wherein the mixing/reaction chambers have a tempering cylinder centrally in the middle of the mixing/reaction chamber. The mixture is continuously drawn off at the bottom or at the cover of the mixing/reaction chambers.

Advantageously, the temperature of the mixing reactions is controlled by the above-mentioned temperature cylinders and/or by the tempering means provided on the outside of the mixing/reaction chambers.

In a further particularly advantageous embodiment, the fluid partial currents are fed into the mixing/reaction chambers such that adjacent fluid partial currents of different reactants cross one another as soon as possible after their entry into the mixing/reaction chambers. This is preferably achieved in that the height of the supply passages and simultaneously their width is designed such that the fluid partial currents are given a preferred flow direction into the mixing/reaction chambers.

It is also possible to mix the fluid partial currents at least partly before they flow into the mixing/reaction chamber. This can be carried out for example in that the supply passages overlap or open into one another directly before the mouth opening, so that the partial currents in the two supply passages come into contact with one another and can mix together directly before penetrating the mixing chamber.

The microstructures present in the mixing/reaction chambers can be fitted both rigidly, by being advantageously manufactured together with the plates or films provided with the supply passages or moulded onto these, and/or as independently manufactured components movably inserted into the mixing/reaction chambers.

The mixing/reaction chamber having an annular cross-section has a diameter of less than 2 mm and preferably has an elliptical cross-section. The fluid partial currents are advantageously supplied in the upper part of the cylindrical mixing chamber if the drawing-off opening is in the bottom, and vice versa. Due to the low height or length of the mixing/reaction chamber, which is preferably between 5 mm and 20 mm long, the losses in pressure in the mixing/reaction chamber can be regarded as small in comparison with the losses in pressure in the pipes. Advantageously, the bottom or the cover, depending on where the mixture is to be drawn off, is formed almost completely open by means of an annular opening. In this way, congested areas of flow around the drawing-off opening are avoided.

Advantageously, the wall thickness between the inside tempering passages and the mixing/reaction chambers and between the mixing/reaction chambers and the outside tempering passages is preferably between 50 μm and 1 mm thick, and especially preferably between 100 μm and 500 μm thick.

Advantageously, the fluids are fed as fluid partial currents in supply passages to the mixing/reaction chambers, wherein the supply passages in the area of the mouth opening preferably have a width between 30 μm and 250 μm and a height between 20 μm and 250 μm. The supply passages are advantageously provided in plates or films with thicknesses preferably between 50 μm and 500 μm, which are stacked over one another. Preferably, the partial currents are guided alternately adjacent and/or above one another, so that partial currents of other fluids are always adjacent and/or above one another, and simultaneously partial currents of different fluids are always fed into the mixing/reaction chambers on the same plane opposite one another.

The micromixing reactor has a fluid distribution plane, by means of which the fluids are variably distributed over one or a plurality of mixing/reaction chambers corresponding to the desired amount of through-flow. Additionally, the micromixing reactor can advantageously be adapted to the amount of through-flow by means of supply passages and by means of the number of plates or films provided with the supply passages.

For measuring the temperature of the mixture, the fluid distribution plane has a temperature sensor which is preferably mounted in or on the outlet passage of the mixture. Especially advantageously, the temperature measurement can be integrated into the mixing/reaction chambers or into or on the outlets of the mixing/reaction chambers.

The device has a plane in which, by means of suitable structures, the possibility is created of guiding a heating or cooling medium back again such that the mixing/reaction chambers can be tempered both from the inside and from the outside by the same cooling or heating medium.

Preferably, the mixing/reaction chambers are arranged in series, or in an alternative embodiment in rows and columns, on the individual films. Here, the compact structural shape advantageously favours the integration of the device in other systems, preferably in microreaction systems, and especially preferably in modular microreaction systems.

In an alternative embodiment, the device has connections between a plurality of mixing/reaction chambers. Hereby, the advantageous possibility is created of improving the mixture by means of serial cycling through a plurality of mixing/reaction chambers.

Preferably, the plates or films from which the micromixing reactor is assembled, consist of sufficiently inert material, preferably metals, semi-conductors, alloys, special steels, composite materials, glass, quartz glass, ceramics or polymer materials, or of combinations of these materials.

Suitable methods for fluid-leak-proof joining of the above-mentioned plates or films are, for example, pressing, riveting, adhesion, soldering, welding, diffusion soldering, diffusion welding, anodic or eutectic bonding.

The structuring of the plates and films can take place, for example, by milling, laser ablation, etching, the LIGA-method, galvanic moulding, sintering, stamping and deformation.

The method and the apparatus are advantageously used for mixing at least two substances, wherein both substances are contained in a supplied fluid or a first substance is contained in a first fluid and a second substance or further substances in one or a plurality of further supplied fluids. Especially advantageously, the method and the apparatus are used for exothermic or endothermic mixing reactions, or alternatively for mixtures wherein an auxiliary substance stabilizing the mixture, or a catalyst supporting the mixing reaction, is added.

The invention is explained in more detail below by way of example, with reference to the drawing. The invention comprises a different number of mixing/reaction chambers, at least one, being connected in series. However, for reasons of clarity, only the structures of one mixing/reaction chamber are shown. These structures are repeated on each plane periodically corresponding to the number of mixing/reaction chambers. Although the invention also makes it possible to feed and simultaneously mix more than two reactants, for reasons of clarity, the invention is explained only by way of example of two reactants.

The drawing shows the following:

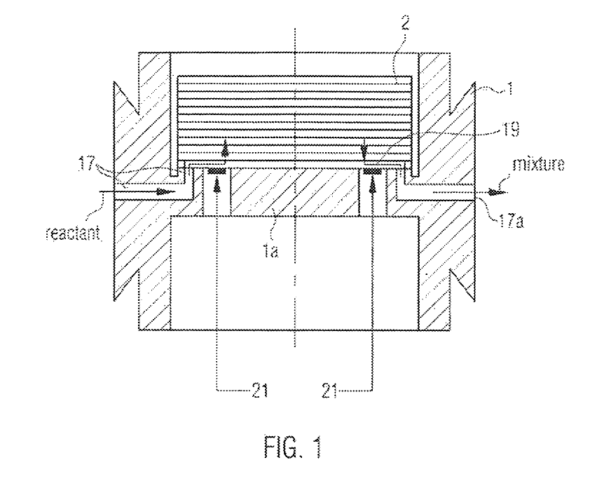

FIG. 1 a cross-sectional view of the microreaction mixer in a casing,

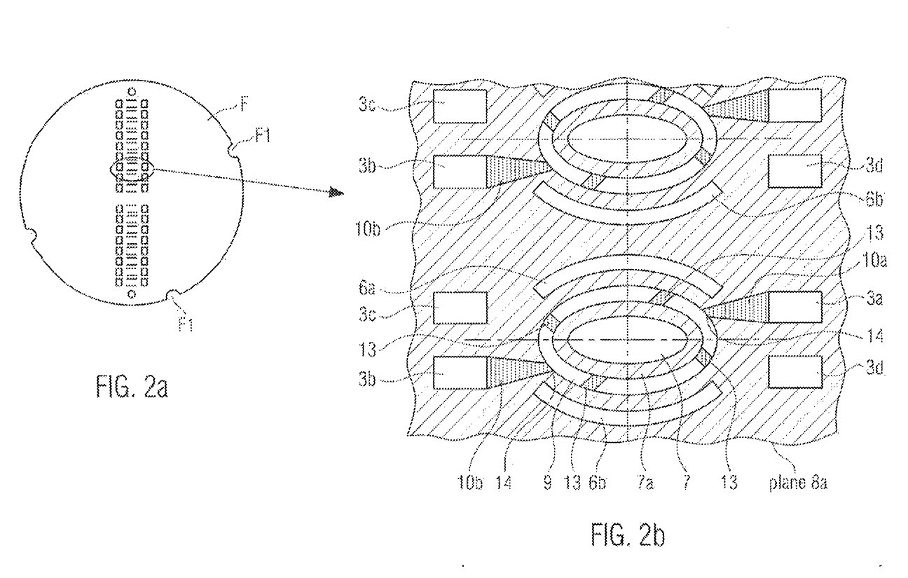

FIG. 2a a representation of a mixing film for plane 8a,

FIG. 2b a detailed view of a mixing film, representing plane 8a,

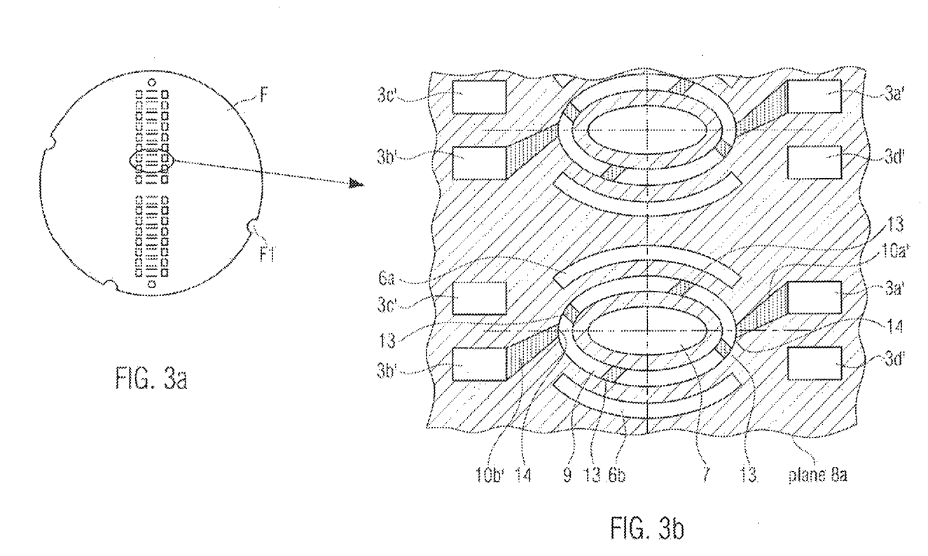

FIG. 3a a representation of a mixing film for plane 8b,

FIG. 3b a detailed view of a mixing film, representing plane 8b,

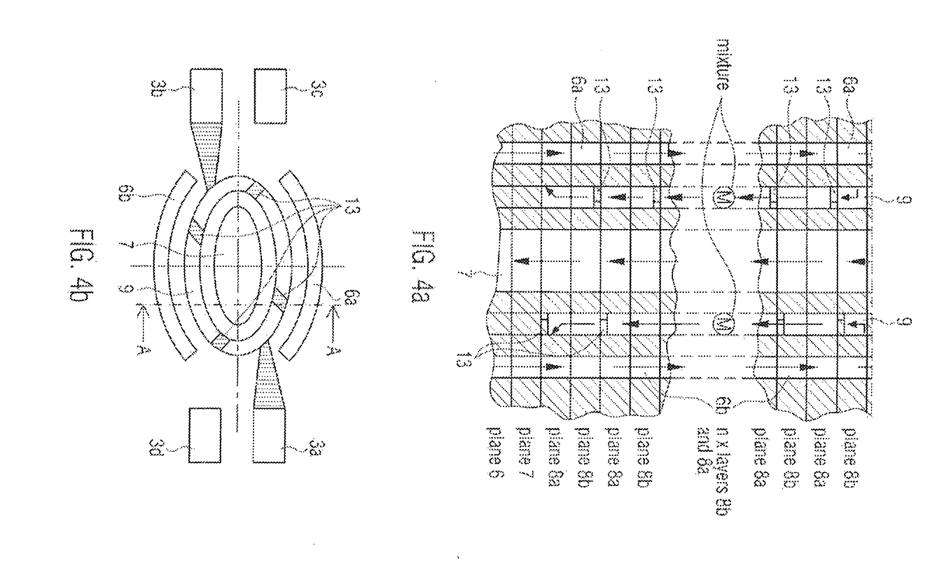

FIG. 4a the structure of the stack of films in cross section over plane 6 to plane 9,

FIG. 4b a plan view of a plane having a mixing chamber in FIG. 4a

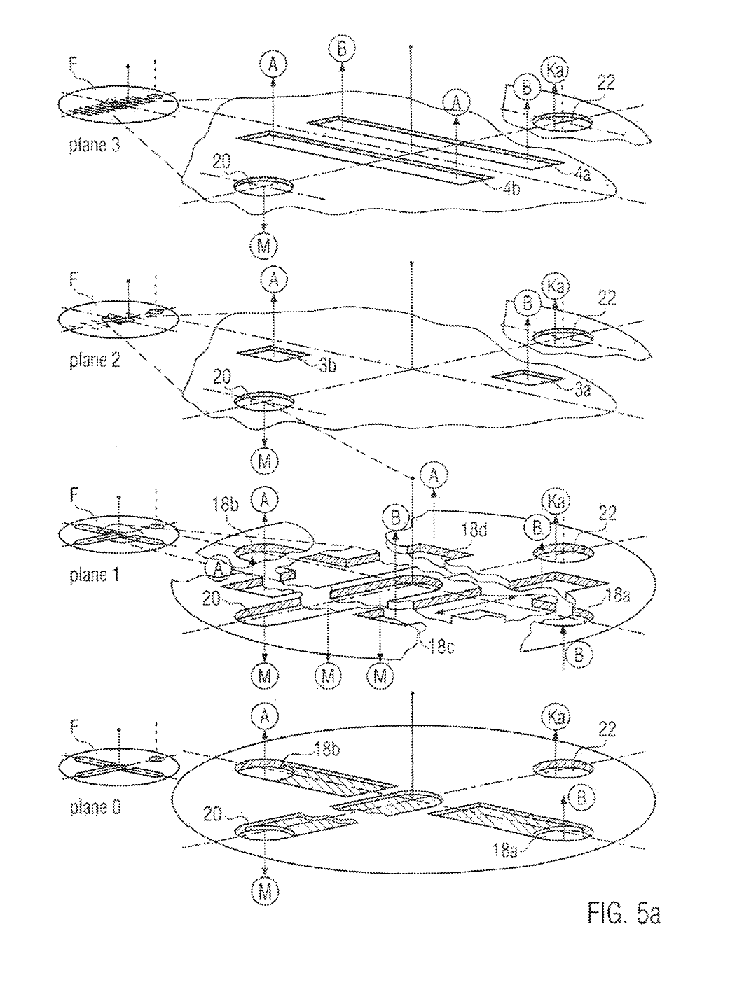

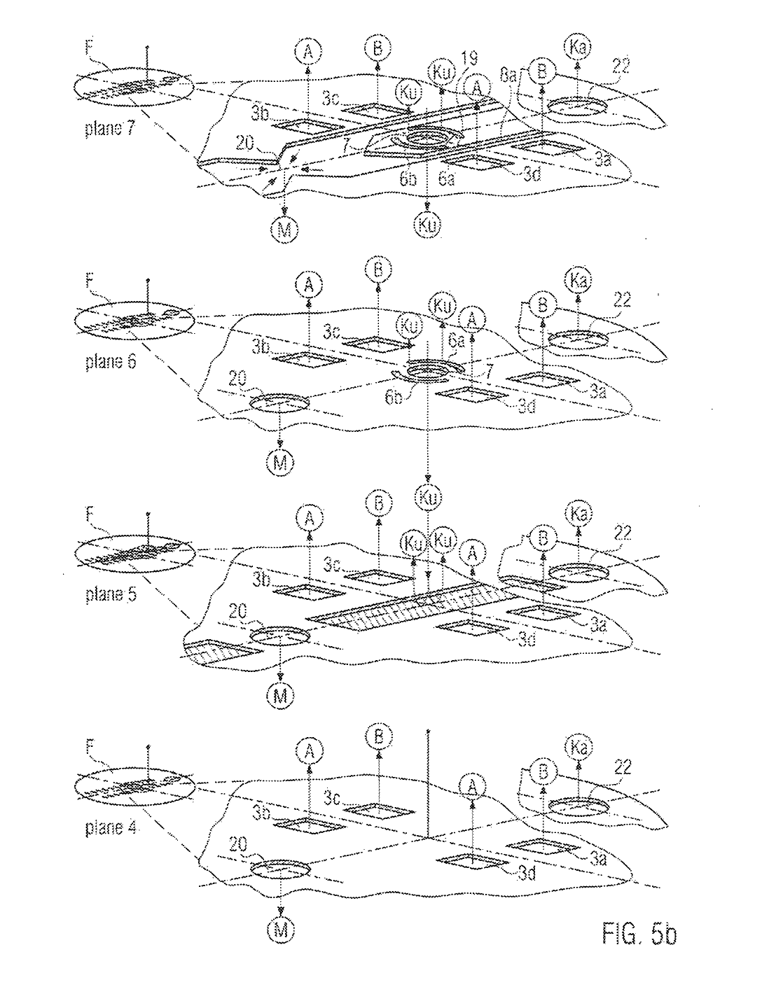

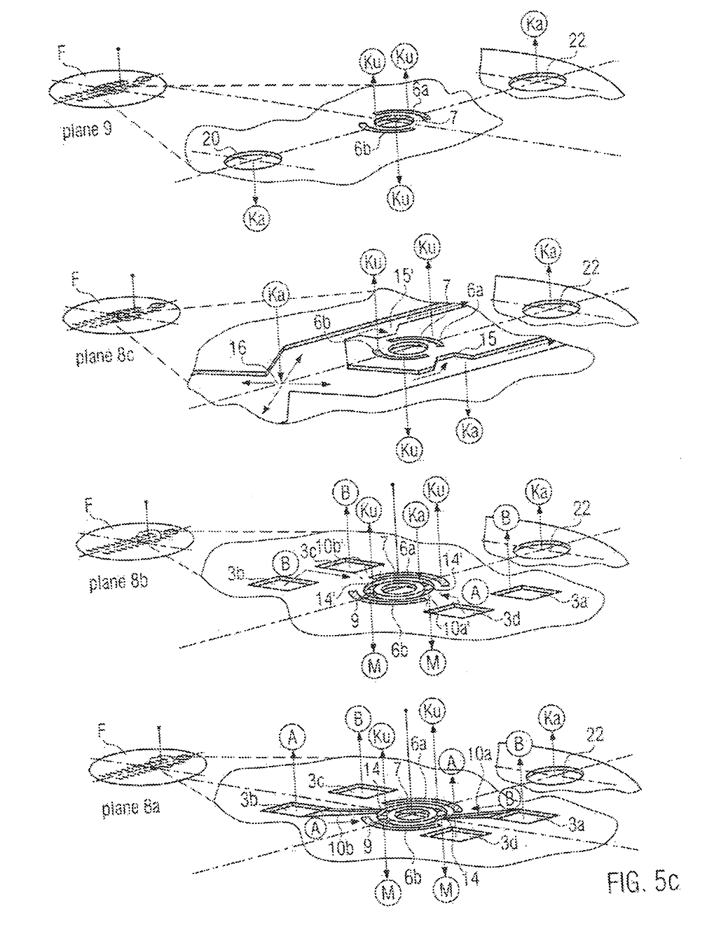

FIG. 5a to a schematic exploded view of the structure of the layers with plane 0 to plane 12,

FIG. 5d

FIG. 6 a microstructure as plane 8c for the alternative embodiment with feeding of a catalyst or of a fluid carrying an auxiliary substance stabilizing a mixture,

FIG. 7 a perspective view of a mixing chamber having supply passages, omitting the film structures for clear illustration of the fluid currents,

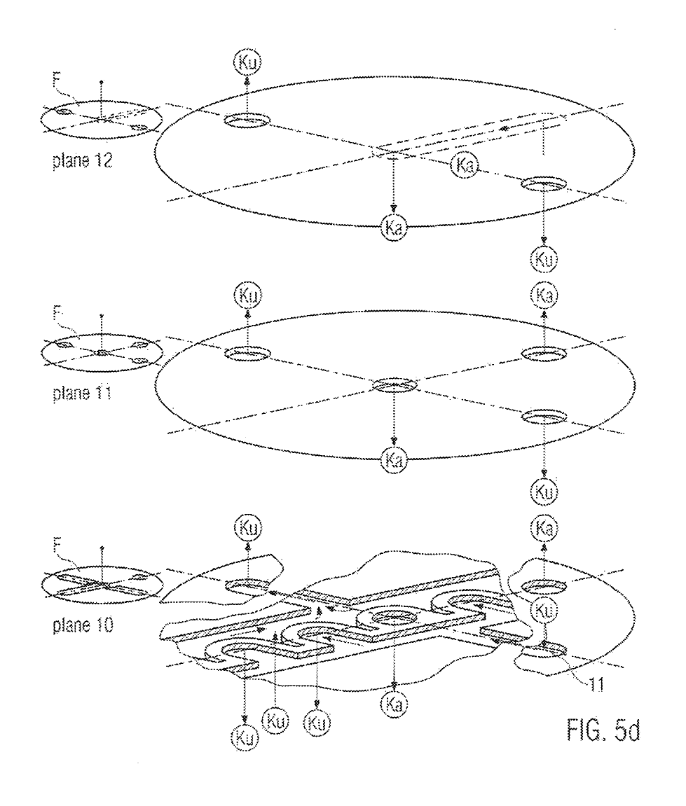

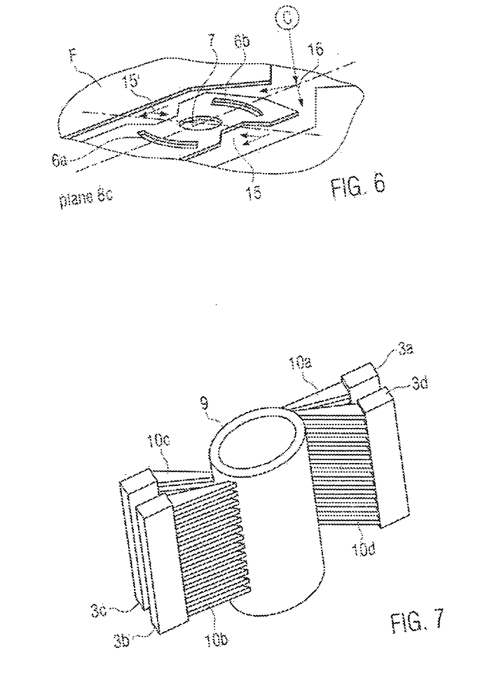

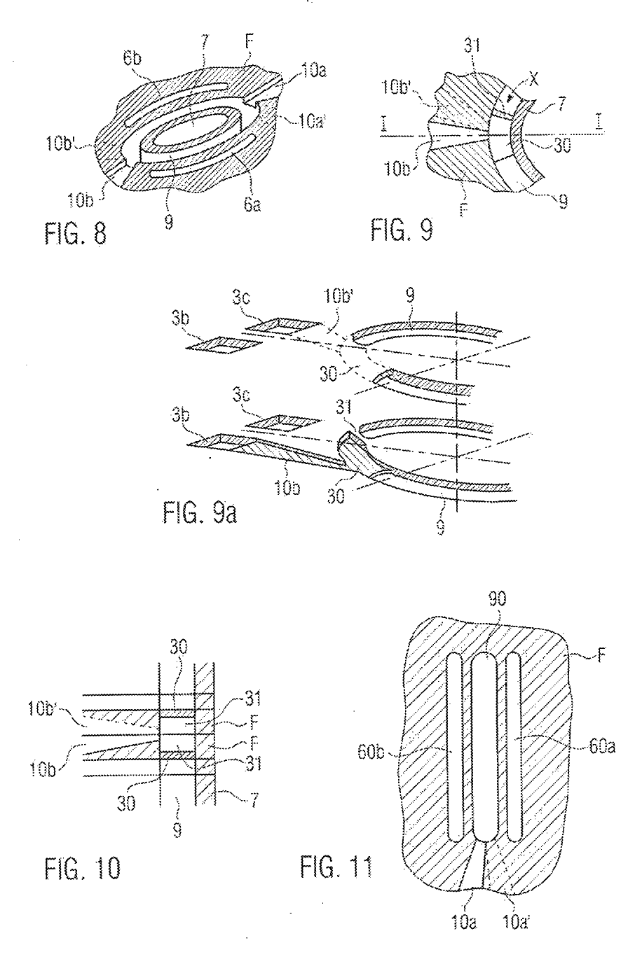

FIG. 8 a schematic view of the structure of a mixing area,

FIG. 9 a plan view of a partition element,

FIG. 10 a sectional view along the line I-I in FIG. 9, and

FIG. 11 a view of another embodiment of a mixing chamber.

FIG. 1 shows as an embodiment a stack 2 of differently structured plates or films, which can have different thicknesses throughout. This stack of films 2 is inserted in a casing 1, wherein the stack 2 is supported on a casing element 1a. By means of lateral bores 17, the reactants A and B to be mixed are fed in. On a third side, the mixture of fed-in reactants A and B is drawn off via one or a plurality of bores 17a.

FIG. 2a shows a plan view of a plate or film F, on which a plurality of microstructures having an annular mixing chamber as represented in FIG. 2b are formed in a row. On the circumference of the disc-shaped film F recesses F1 are provided for positioning the film in the casing 1.

By means of the bores 17, the reactants A and B reach corresponding feed-through bores in a plane 0 of a film F in FIG. 5a and from this they reach a fluid distribution plate (plane 1). The supply passages 18a and 18b, which are formed from microstructures produced for example by etching, bring the reactants into the distributor arms 18c and 18d. The length of the distributor arms 18c and 18d determines how many mixing/reaction chambers 9 are used for mixing. In this way, a possibility is created of adapting the mixing/reaction capacity in a simple way to the amounts of through-flow of the fluids.

The next film (plane 2) has two holes 3a and 3b. Through these holes 3a and 3b, the reactants A and B reach the distributing passages 4a and 4b of plane 3 thereabove. By means of this structuring, a first division of the fluid currents is achieved, so that on planes 8a and 8b these can be fed into the mixing/reaction chambers 9 both above and adjacent one another and opposite one another.

The reactants A and B flow via holes 3a and 3c (for example reactant A) and holes 3b and 3d in planes 4 to 7 (FIG. 5b) up to planes 8a and 8b, on which the actual mixing takes place. Annular mixing/reaction chambers 9 are formed by alternately stacking the films with plane 8a and plane 8b. On the planes 8a, horizontal supply passages 10a and 10b are connected to the holes 3a and 3b and guide the reactants A or B to the mixing/reaction chambers 9. The holes 3c and 3d serve only to guide reactants A and B further to the next plane 8b. The supply passages 10a and 10b are microstructured such that they narrow horizontally towards the mouth openings 14. Further, it can be provided to narrow the mouth openings 14 not only horizontally, but simultaneously to decrease their depth. Hereby a directed in-flow of the fluid partial currents slightly upward into the chamber 9 is achieved.

The holes 3c and 3d on plane 8b are connected to the supply passages 10a′ and 10b′. The films of plane 8b are stacked in an advantageous way with the microstructured side facing downward, so that the reactants B or A are guided at approximately the same height into the mixing/reaction chambers 9. Due to the stacking of the film with the microstructuring facing downward, the supply passages 10a′ and 10b′ guide the reactants A and B to the mouth openings 14′ now slightly downwardly directed into the mixing/reaction chambers 9. Hereby it is achieved in a simple way that fluid partial currents of the reactants A and B cross, penetrate and thus mix with one another practically directly after they flow into the mixing/reaction chambers 9.

The adaptation of the mixing/reaction capacity to the amounts of through-flow does not only take place by means of the length of the distributor arms 1c and 1d on the distributor plate (plane 1), but also by means of the number of repetitions of films of the planes 8a and 8b, which each have an annular mixing/reaction chamber 9.

Other mixing ratios than 50:50 of reactants A and B are achieved for example in that a corresponding number of films of plane 8a and/or 8b have no supply passages 10a to 10b′. Another form of adaptation to different mixing ratios is achieved in an advantageous way in that a different number of films of the planes 8a and 8b are stacked.

A film F according to FIGS. 2a and 2b corresponds to the plane 8a in FIG. 5c, while the corresponding representation in FIGS. 3a and 3b corresponds to plane 8b. In this exemplary embodiment, the annular mixing/reaction chambers 9 are designed oval around a central hollow cylinder 7 having an oval cross section, through which a tempering fluid flows. The wall thickness 7a of this tempering cylinder 7 is preferably smaller than 1 mm, for example 50 to 100μ, preferably 300μ. On the outer circumference the annular chambers 9 are surrounded on the long sides by a longitudinal return passage 6a and 6b, through which fluid for tempering the mixing/reaction chamber 9 also flows. Correspondingly, the wall thickness between these flat, curved passages 6a, 6b and the reaction chambers 9 is formed thin, preferably less than 1 mm, for example 50 to 100μ, preferably 300μ.

In FIGS. 2b and 3b it can be seen that the reactants A and B flow into the mixing/reaction chambers 9 at four different positions 14, 14′. In an alternative embodiment not shown here, the fluid distribution plate (plane 1) can be structured such that different reactants flow through each of the holes 3a, 3b, 3c and 3d. In this case, the distributing passages 4a, 4b (plane 3) are not required. In such an embodiment, the simultaneous mixing of up to four reactants is possible.

By the hatching of the passages 10a and 10b and of 10a ′ and 10b′ in FIGS. 2b and 3b, an extension of the passage inclined to the plane of projection is indicated.

As FIG. 4a shows, the annular reaction chambers 9 are sealed at the top by a film of plane 9 and at the bottom by a film of plane 7 to be fluid-leak-proof in the axial direction, wherein openings remain for the mixture to flow off.

The mixture flows downwards in the mixing/reaction chambers 9, to flow out on plane 7 (FIG. 5b) through outlets 19 in the form of microstructured recesses in the collector passages 8a and 8b. The outlets 19 can alternatively also be designed in the form of a single annular outlet. Simultaneously, the film of plane 7 seals the mixing/reaction chambers 9 to be fluid-leak-proof in a downward direction. Via the collector passages 8a and 8b, the mixture finally reaches the outflow opening 20 on planes 1 and 0.

Temperature measuring can take place directly adjacent the mixing/reaction chambers 9 by means of temperature sensors 21 (FIG. 1). Here, both the temperature of the fed-in reactants A and B and the temperature of the mixture can be detected. In the embodiment according to FIG. 1, the temperature sensors 21 are arranged in holes in the casing element 1a in the area of the passages 18a and 18b, and in the area of the outlet formed by the recess 19.

The temperature of the mixing reaction can be directly controlled for example by a tempering fluid Ku. The tempering fluid Ku is fed in through a supply passage 11 on plane 10 to the tempering cylinders 7 from above on plane 9. The tempering fluid flows downwardly inside the tempering cylinder 7 and in this way cools or heats the inside surface of the mixing/reaction chambers 9, which are formed in the shape of a circular ring. As the wall thicknesses are between 50 μm and 1 mm thick, there results a very effective heat transfer to the mixture or carrying off of heat from the mixture, by which means isothermal processing conditions are maintained, even during strongly exothermic or endothermic mixing reactions.

The tempering cylinders 7 are held by microstructured bridges 13 in the mixing/reaction chambers 9. These microstructures 13 simultaneously provide additional swirl to reactants A and B and thus allow faster mixing. Advantageously, the positions of the microstructures 13 are provided such that they do not lie directly above one another in the case of a rotation of the films of planes 8b. Thus it is achieved in a simple way that the reactants A and B can flow between the microstructures 13 of the different planes. As FIG. 4a shows, the bridges 13 have a lesser thickness than the related film on which they are formed or moulded, so that a bridge 13 does not extend over the whole thickness of the film. In FIG. 4b, I-I shows the section of the sectional representation in FIG. 4a.

Alternatively, for pre-heating the reactants A and B even before the mixing/reaction chambers 9, films can be inserted between each of the films of planes 8a and 8b, which films are provided with heating means, for example in the form of structured passages through which a heating fluid flows.

In an alternative embodiment, both the microstructures 13 and the walls of the mixing/reaction chambers 9 are coated with a catalyst. In addition, an alternative is provided according to which the films of planes 8a and 8b are completely made from a catalytic material.

On plane 5, the tempering fluid Ku flows into a collecting pan 5. Subsequently it is pressed back up through the return guides 6a and 6b, this time outside along the mixing/reaction chambers 9. Thus, in an advantageous way, the outer surfaces of the mixing/reaction chambers 9 are now tempered as well. Here too, the wall thickness between the return guides 6a and 6b and the mixing/reaction chambers 9 is between 50 μm and 1 mm thick, so that again very good heat transfer is achieved. Simultaneously, the return guides 6a and 6b serve to thermally insulate the chambers 9. The tempering fluid Ku is finally drawn off through the drawing-off passage 12 on plane 10.

Alternatively, in the central tempering cylinder 7 and/or in the return guides 6a and 6b, a heating means can be fitted, for example, an electric heating means, for example, in its most convenient form by means of electrically insulated heating resistor wires or heating resistor films.

In an alternative embodiment not shown here, the mixture is not drawn off through the outflow opening 20, but rather for improving the resulting mixture or for admixing further reactants or for extending the dwell time, it is supplied to further mixing/reaction chambers 9, which are arranged parallel to the series of the first mixing/reaction chambers 9. Due to the small geometrical extent of the mixing/reaction chambers 9, this serial supply can take place in a very small space.

In a further advantageous embodiment, a fluid Ka carrying a catalyst or an auxiliary substance stabilizing the mixture is supplied to the mixing/reaction chambers 9. The fluid Ka is supplied via the distributor structure 16 of plane 8c (FIG. 6).

From there, it flows via holes 15 and 15′ for example from above into the mixing/reaction chambers 9, in as far as the mixing/reaction chamber opening 19 is positioned under the mixing/reaction chambers 9. Otherwise, the supplying takes place from below. In this way, it is achieved that for example the catalyst has the longest possible dwell time in the mixing/reaction chambers 9 and effectively contacts all the fluid partial currents.

Alternatively, the fluid Ka, which is supplied via the holes 15 and 15′, is for example an inert substance which is supplied in adapted amounts, so that as a propelling medium it presses the mixture acceleratedly out of the mixing/reaction chambers 9 and thus achieves a considerably reduced dwell time for the mixture. In this way, dwell times of less than one microsecond can be achieved, which is especially advantageous in extremely fast mixing reactions. Hereby, congesting of the apparatus is prevented.

FIG. 5b shows in plane 7 the structure of the flow-off passage 20 of the mixture, wherein on two passages 8a and 8b extending laterally approximately tangentially to the annular chambers 9, holes or recesses 19 are formed between the flat passages 6a and 6b, which holes or recesses communicate with the reaction chambers 9 lying thereabove in plane 8a in this embodiment. As FIG. 5b shows, the mixture M produced in the reaction chamber 9 penetrates downwardly through the recesses 19 in plane 7 and reaches the outlet opening 20. Although the film or plane 7 seals the annular reaction chambers 9 of planes 8 axially downwardly to make them fluid-leak-proof, it simultaneously forms flow-off openings by means of the recesses 19. In a modified embodiment, such flow-off openings 19 can also be provided on the film or plane covering the top of the reaction chamber 9, according to the type of operation of the apparatus.

The described microstructure for mixing at least two fluids can have very small dimensions. The thickness of the plates or films F can be between 50 and 500μ. The wall thickness between the flat passages 6a, 6b and the reaction chamber 9 and the wall thickness 7a of the tempering cylinder 7 can preferably be between 50 and 500μ. and especially between 100 and 300μ. The tempering cylinder 7 can have a diameter of less than 1 mm in at least a horizontal direction. Correspondingly, the diameter of the annular reaction chamber 9 can be less than 2 mm at least in a horizontal direction. On the other hand, the height of the reaction chamber 9 can be designed according to requirements and have a dimension between, for example, 1 mm and 20 mm.

FIG. 7 shows a perspective view of the fluid currents, wherein for clarification of the course of the current, the surrounding film structures are omitted. The blocks 3a to 3d arranged at a distance from the mixing chamber 9, which in this embodiment is hollow cylindrical, represent the holes formed in the individual film layers, from which, substantially in the plane of the individual films, supply passages 10a to 10d lead radially into the hollow cylindrical mixing chamber 9. The supply passages 10a and 10b branching off horizontally from the vertical passages 3a and 3b lie approximately in two parallel planes which intersect the hollow cylinder of the mixing chamber 9, while the supply passages 10c and 10d branching off horizontally from the vertical passages 3c and 3d extend inclined to the supply passages 10a and 10b, so that the fluids flowing in through the adjacent supply passages 10a, 10d, and 10c, 10b cross and mix with one another directly on entering the mixing chamber 9. The supply passages 10c and 10d also lie in vertical planes which are parallel to one another, but which intersect the vertical planes of the supply passages 10a and 10b.

As can be seen from FIG. 7, the supply passages 10c and 10d are inclined in the axial direction in relation to the horizontally extending supply passages 10a and 10b, for orienting toward one another the fluid currents penetrating into the mixing chamber from the mouth openings of the supply passages, so that the fluid currents cross one another not only in the horizontal plane, but also in the vertical direction along the axis of the mixing chamber 9.

FIG. 8 shows schematically a perspective view of the basic construction of the mixing area with the tubular tempering cylinder 7 in the mixing chamber 9, into which supply passages 10a, 10b and 10a′, 10b ′, extending inclined towards one another, open on the individual film planes, wherein in the area of the circumference of the mixing chamber 9, which remains free between the supply passages 10a to 10b ′, passages 6a, 6b are formed for a cooling or heating medium, which flows around the mixing chamber 9 on the outer circumference in the direction of the axis of the construction. Because the cross section of the mixing chamber 9 is designed oval and the supply passages 10a to 10b′ open in the area of the opposite narrow sides having a greater curve, on the longitudinal sides having the lesser curve a larger area remains for heat supply or removal by means of the medium flowing through the outer passages 6a, 6b in comparison to a circular cross-sectional shape of the mixing chamber 9.

Additionally, in the area of the greater curve of the mixing chamber 9, the supply passages 10a and 10b or 10a′ and 10b ′ can be directed more strongly towards one another, so that the fluid currents cross one another and are mixed together directly on entering the mixing chamber.

FIG. 9 shows a plan view of the annular mixing chamber 9 in the mouth area of two supply passages 10b and 10b ′, formed in films which abut on one another and extending at an angle to one another. As, in the axial direction of the mixing chamber, the mixing areas of in each case two passages lie directly over one another, it can be expedient, as FIG. 7 shows, to divide the individual mixing areas from one another by a partition element 30, so that at the individual film layers fluids flowing in do not hinder the mixing of two partial currents and an uncontrolled flow in the axial direction of the mixing chamber 9 is prevented. Preferably, the partition element 30 extends in a plate shape in the circumferential direction of the mixing chamber 9 only in the mouth area of two supply passages 10a, 10a′ and 10b, 10b ′, as the plan view in FIG. 9 shows. FIG. 10 shows the overlapping partition elements 30 in a schematic sectional view along the line I-I in FIG. 9, wherein in each case a partition element 30 is allocated to two film layers with the supply passages formed therein. The partition elements 30 can be formed or moulded directly on the films F, as FIG. 9a shows in perspective view.

According to the diameter of the mixing chamber 9 and the flow velocity of the fluids supplied diametrically opposite one another, it can be expedient to divide the mixing area of two supply passages from the next mixing area not only in the axial direction by the partition element 30, but also to shield the mixing area from a current in the circumferential direction of the mixing chamber 9, so that the mixing process of the crossing fluid currents directly after emerging from the supply passages is not adversely affected by the total current in the circumferential direction in the mixing chamber 9, if for example due to a high feed velocity of the supply passages 10a, 10a′ opening at an angle, a strong current of the mixed fluids should arise in the circumferential direction of the mixing chamber. To shield the mixing area in the circumferential area of the mixing chamber, in the embodiment according to FIGS. 9 and 10 on the horizontal partition element 30 a shield screen 31 is formed extending in the axial direction, by means of which the mixing area is shielded from a current in the circumferential direction, which is indicated in FIG. 9 by the arrow X. The supply passage 10b ′ opening at an angle in the embodiment according to FIG. 9 supports a current in the anti-clockwise direction in the mixing chamber 9.

As FIGS. 9a and 10 show, the shield screen 31 can extend between adjacent partition elements 30, so that by means of the successive shield screens 31 a partition wall results in the axial direction in the mixing chamber 9. However, it is also possible to form the shield screen only over a partial area of the distance between overlying partition elements 30.

In the embodiment shown in FIGS. 9, 9a and 10, the shield screen is moulded onto the partition element 30, so that altogether an L-shaped cross section of the structure results. However, it is also possible to arrange the shield screen 31 at a distance before the partition element 30 between the inner and the outer circumference of the mixing chamber 9, so that between the partition element 30 and the shield screen 31 a free space remains in the axial direction of the mixing chamber 9,

FIG. 11 shows a plan view of a simplified embodiment of holes in a film F for forming a mixing chamber 90 having a long cross section, on whose two sides in cross section long passages 60a and 60b are formed for a cooling or heating medium. On the narrow side of the long mixing chamber 90, supply passages 10a, 10d open inclined towards one another. In this embodiment too, the mixing of the two partial currents from the supply passages 10a and 10d takes place directly on entry into the mixing chamber 90, wherein corresponding temperature control of the mixing process can take place by means of the tempering passages 60a and 60b.

The mixing chamber 90 has a long shape, so that sufficient space exists for the whole volume of the single partial currents which are supplied on the various film planes. According to the kind of inflow amount into the mixing chamber, this can also have a different cross section from the one shown. For example, the mixing chamber 90 can be shaped curved in the view in FIG. 11.

In an embodiment according to FIG. 11, it is also possible to design the mixing chamber 90 broadening from top to bottom in the axial direction, when the total mixture is drawn off at the bottom of the film stack, wherein in this embodiment too, the mouth opening substantially corresponds to the cross sectional shape of the lowest mixing chamber 90. In other words, in such an embodiment, the uppermost mixing chamber 90 can have a shorter length than the lowest mixing chamber, so that from top to bottom an enlarging cross section results, corresponding to the amount of fluid flows additionally supplied from tier to tier or plane to plane.

As can be seen from a comparison of FIGS. 11 and 8, an overall more compact and effective structure can be achieved for an approximately cylindrical or annular embodiment of the mixing chamber 9, than for the structure according to FIG. 11, wherein by impinging of the partial currents on the wall of the tempering means or of the tempering cylinder 7, on the one hand mixing together is supported and on the other hand the temperature control is improved.

In the structure according to FIG. 11, the two tempering passages 60a and 60b can also be joined to one another at the end of the mixing chamber 90 opposite the mixing area, so that they surround the mixing chamber 90 at its end portion too.

According to a modified embodiment, the supply passages 10a and 10b can overlap and cross one another directly before the mouth opening into the mixing chamber, such that the fluid partial currents in the two supply passages can already contact one another and mix together shortly before entering the mixing chamber, wherein the mixing process is continued on entry into the mixing chamber. In other words, in such an embodiment a partition wall is omitted between the adjacent supply passages shortly before the opening area.

1-12. (canceled)

13. Method for mixing at least two fluids in a micromixing reactor constructed from a stack of films or thin plates,
wherein a mixing chamber extends transverse to the film planes, and the fluids for mixing are introduced separately and adjacent one another on the film planes transverse to the longitudinal axis of the mixing chamber, so that the mixing of the fluids substantially takes place directly on their introduction into the mixing chamber, and
wherein the resulting mixture is tempered at least on a section of the circumference of the mixing chamber by a tempering means.

14. Method according to claim 13, wherein a catalyst or an auxiliary substance supporting the mixing is added in partial amounts to the fluids supplied on the film planes, and/or the fluids are guided over a catalyst provided on the inside walls of the supply passages and/or of the mixing chamber.

15. Micromixing reactor for mixing at least two fluids constructed from a stack of films or thin plates,
wherein a mixing chamber extends vertical to the film planes,
supply passages for the fluids to be mixed are formed in the planes of the films, the mouth openings of which supply passages are provided in the mixing chamber adjacent or above one another, and
wherein the mixing chamber has a tempering means on at least one portion of its circumference.

16. Micromixing reactor according to claim 15, wherein the mixing chamber has a long cross-sectional shape and the supply passages open into this in the area of a narrow side of the mixing chamber.

17. Micromixing reactor according to claim 16, wherein on at least one broad side of the mixing chamber a tempering passage is formed extending parallel to the mixing chamber.

18. Micromixing reactor according to claim 15, wherein the mixing chamber is formed approximately annular in cross section, and is delimited from the tempering means on the inner circumference,
wherein on approximately diametrically opposite sides of the mixing chamber, supply passages open for the fluids to be mixed.

19. Micromixing reactor according to claim 18, wherein on the outer circumference of the mixing chamber between the supply passages, tempering passages are formed extending parallel to the mixing chamber.

20. Micromixing reactor according to claim 15, wherein in the axial direction of the mixing chamber between the overlapping mixing areas, partition elements are provided, which extend in the mouth area parallel to the film planes.

21. Micromixing reactor according to claim 18, wherein in the circumferential direction of the mixing chamber before the individual mixing areas a shield screen is arranged, which extends approximately parallel to the axis of the mixing chamber.

22. Micromixing reactor according to claim 18, wherein the tubular tempering cylinder is formed in the mixing chamber by holes and wall sections of the individual plates or films stacked over one another, and the wall sections of the tempering cylinder are held by moulded-on bridges.
